(19) United States
(12) Patent Application Publication
(10) Pub. No.: US 2022/0122413 A1
(43) Pub. Date: Apr. 21, 2022

(54) PRELOADING WAGERS

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/476,862

(22) Filed: Sep. 16, 2021

Related U.S. Application Data
(60) Provisional application No. 63/094,505, filed on Oct. 21, 2020.

(51) Int. Cl. G07F 17/32

(52) U.S. Cl. CPC G07F 17/3227; G07F 17/323; G07F 17/3237; G07F 17/3288

(57) ABSTRACT

A method of providing odds more quickly by calculating the odds for subsequent plays based on the variety of potential outcomes for the current play. Odds for the third pitch in an at-bat based on if the second pitch ends up being a ball or a strike.

### FIELD

The embodiments are generally related to play by play wagering on live sporting events.

### BACKGROUND

Current sports betting platforms provide numerous different ways to wager on entire sporting events or individual aspects or portions of those events. One problem that arises with placing bets during a live event is that the placing of the bet and the subject of the bet (i.e., the next play of the game) are very close to each other in time. This means the window for placing a bet may only be open for a matter of minutes or seconds.

As the betting window must close before the portion of the event is complete, users need to be made aware of how little time they have left so that they are not cut off from making a wager. If, for example, a user is in the middle of placing a bet and the next play of the game begins, the user will lose the ability to finish making that bet. This may lead to users becoming frustrated.

The time required to calculate odds by different methods varies, but often, to increase the speed at which odds are calculated, the accuracy of those odds must be reduced. Thus, there is a need to create a balance between the accuracy of odds and the speed at which those odds are calculated. Further, there is a need to substitute more accurate odds for the quickly calculated odds when they become available.

### SUMMARY

A method and system for generating odds in a play-by-play sports betting network. In one embodiment, the system can include a database storing wagers of a play-by-play wagering game during a live sporting event, an odds calculation module that performs at least four different calculations for odds on a play of the live sporting event, and a hybrid odds module that receives odds from the odds calculation module and determines hybrid odds using at least two of the four different calculated odds, wherein the hybrid odds are for a play immediately following a next play and the odds are modified based on historical data.

### BRIEF DESCRIPTIONS OF THE DRAWINGS

The accompanying drawings illustrate various embodiments of systems, methods, and various other aspects of the embodiments. Any person of ordinary skill in the art will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: Illustrates a voice-based wagering system, according to an embodiment.

FIG. 2: Illustrates a base wagering module, according to an embodiment.

FIG. 3: Illustrates a generic odds module, according to an embodiment.

FIG. 4: Illustrates a team odds module, according to an embodiment.

FIG. 5: Illustrates a player odds module, according to an embodiment.

FIG. 6: Illustrates a filtered odds module, according to an embodiment.

FIG. 7: Illustrates a hybrid odds module, according to an embodiment.

FIG. 8: Illustrates a bettor odds module, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “bet” or “wager”. A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, or perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are services that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, by creating and delivering actionable insights on performance to help customers to manage the sports gaming. Business Applications can be integrated into the embodiments in a variety of manners.

State based integration allows for a given sports gambling game to be modified by states in the United States or other countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

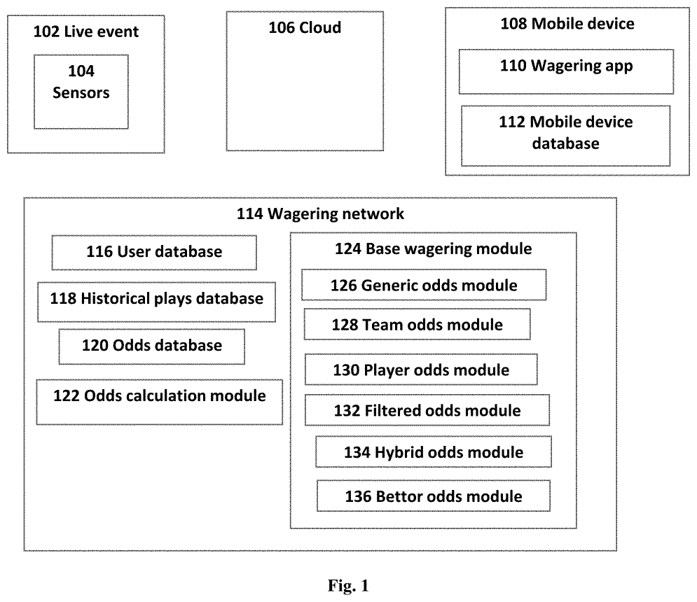

FIG. 1 is a system for voice-based wagering. This system may include a live event 102, for example, a sporting event such as a football game, basketball game, baseball game, hockey game, tennis match, golf tournament, eSports or digital game, etc. The live event 102 will include some number of actions or plays, upon with a user or bettor or customer can place a bet or wager, typically through an entity called a sportsbook. There are numerous types of wagers the bettor can make, including, but not limited to, a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points to move the point spread off of the opening line. This will increase the price of the bet, sometimes by increasing the juice, vig, or hold that the sportsbook takes. Another type of wager the bettor can make is an over/under, in which the user bets over or under a total for the live event 102, such as the score of an American football game or the run line in baseball, or a series of actions in the live event 102. Sportsbooks have several bets they can handle, which can be a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves, there becomes an opportunity for a bettor to bet on both sides at different points, in order to middle and win both bets. Sportsbooks will often offer bets on portions of games, such as first-half bets and half-time bets. Additionally, the sportsbook can offer futures bets on live events 102 in the future. Sportsbooks need to offer payment processing services in order to cash out customers. This can be done at kiosks at the live event 102 or at another location.

Further, embodiments may include a plurality of sensors 104 that may be used such as motion sensors, temperature sensors, humidity sensors, optical sensors and cameras, such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 104 may include tracking devices, such as RFID tags, GPS chips, or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 106 or a communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), radio waves, and other communication techniques are known in the art. The communication network may allow ubiquitous access to shared pools of configurable system resources and higher-level services that can be rapidly provisioned with minimal management effort, often over the internet, and relies on sharing of resources to achieve coherence and economies of scale, like a public utility. In contrast, third-party clouds allow organizations to focus on their core businesses instead of expending resources on computer infrastructure and maintenance. Cloud 106 may be communicatively coupled to peer-to-peer wagering network 114, which may perform real-time analysis on the type of play and the result of the play. The cloud 106 may also be synchronized with game situational data, such as the time of the game, the score, location on the field, weather conditions, and the like, which may affect the choice of play utilized. For example, in other exemplary embodiments, the cloud 106 may not receive data gathered from sensors 104 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or group of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 108 could be an optional component and would be utilized in a situation where a paired wearable device utilizes the mobile device 108 as additional memory or computing power or connection to the internet.

Further, embodiments may include a wagering software application or wagering app 110, which is a program that enables the user to place bets on individual plays in the live event 102 and displays the audio and video from the live event 102, along with the available wagers on the mobile device 108. The wagering app 110 allows the user to interact with the wagering network 114 to place bets and provide payment/receive funds based on wager outcomes.

Further, embodiments may include a mobile device database 112 that may store some or all of the user's data, the live event 102, or the user's interaction with the wagering network 114.

Further, embodiments may include the wagering network 114, which may perform real-time analysis on the type of play and the result of a play or action. The wagering network 114 (or cloud 106) may also be synchronized with game situational data, such as the time of the game, the score, location on the field, weather conditions, and the like, which may affect the choice of play utilized. For example, in some exemplary embodiments, the wagering network 114 may not receive data gathered from sensors and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 114 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 116, which may contain data relevant to users of the wagering network 114, which may include, but is not limited to, a user ID, a device identifier, a paired device identifier, wagering history, and wallet information for the user. The user database 116 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 116 may contain betting lines and search queries. The user database 116 may be searched based on a search criterion received from the user. Each betting line may include a plurality of betting attributes such as at least one of the live event 102, a team, a player, an amount of wager, etc. The user database 116 may include information related to all the users involved in the live event 102. In one example embodiment, the user database 116 may include information for generating a user authenticity report and a wagering verification report. Further, the user database 116 may be used to store user statistics including, but not limited to, the retention period for a particular user, frequency of wagers placed by a particular user, or the average amount of wager placed by each user.

Further, embodiments may include a historical play database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120 that contains the odds calculated by an odds calculation module 122 to display the odds on the user's mobile device 108 and to take bets from the user through the mobile device wagering app 110.

Further, embodiments may include the odds calculation module 122, which utilizes historical play data to calculate odds for in-play wagers

Further, embodiments may include a base wagering module 124, which may allow the user to place wagers on the live event 102. The module initiates a generic odds module 126, a team odds module 128, a player odds module 130, a filtered odds module 132, a hybrid odds module 134, and a bettor odds module 136.

Further, embodiments may include the generic odds module 126, which may be executed by receiving data about the current play in the live event 102 and then determining the next play and the odds of the next play in advance to make the system more efficient and to provide the player of the game insight into the next play in order to get the player to bet on the current play and/or the next play. For example, if there are two outs in a baseball game, and a batter has two strikes and no balls, the next pitch could lead to only several conclusions, e.g., another strike or out ends the inning, or the inning continues because there is a ball called or a hit or a foul. The odds of each next possibility can be calculated based on averages of some or all games in the historical plays database 118. This is useful as baseline odds calculations, particularly if there are issues with more specific analysis, such as heavy weather affecting the precise analysis of the players and both teams. It should be noted that the odds calculations can be a simple average, or it could be an average of a subset of all the data, where the subset is chosen from filtering out data to make the average closer to the norm, such as filtering out abnormal games (e.g., lasted more than ten innings, etc.).

Further, embodiments may include the team odds module 128, which may be executed by receiving data about the current play in the live event 102 and then determining the next play and the odds of the next play in advance to make the system more efficient and to provide the user of the system insight into the next play in order to get the user to bet on the current play and/or the next play. For example, if there are two outs in a baseball game, and a count is no balls and two strikes, the next pitch could lead to only several conclusions, e.g., another strike or an out would end the inning, or the inning may continue if there is a ball called, or a hit, or a foul. The odds of each next possible outcome may be calculated based on averages of some or all games between these two teams in the historical plays database 118. This is useful as baseline odds calculations, as they are likely to be more accurate than odds calculated from generic history data. It should be noted that calculated odds could be based upon correlation calculations, such as but not limited to regression analysis, that is, if one of the possibilities of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

Further, embodiments may include the player odds module 130, which may be executed by receiving data about the current play in the live event 102 and then determining the possible contexts of the next play and the odds of at least one potential outcome of the next play, in advance to make the system more efficient and to provide the user of the game insight into the next play in order to get the user to bet on the current play and/or the next play. For example, if there are two outs in a baseball game, and the count is no balls and two strikes, the next pitch could lead to only several conclusions, e.g., another strike or an out ends the inning, or the inning may continue if there is a ball called, or a hit, or a foul. The odds of each next possibility may be calculated based on averages of some or all games ever played between these two teams playing as well as the historical interactions between a given pitcher and a given batter in the historical plays database 118. This is useful as baseline odds calculations, as they are likely to be more accurate than calculated odds from generic history data and likely more accurate than calculated odds from team history data. It should be noted that calculated odds could be based upon correlation calculations, such as but not limited to regression analysis, that is, if one of the possibilities of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

Further, embodiments may include the filtered odds module 132, which may be executed by receiving data about the current play in the live event 102 and then determining the next play and the odds of the next play in advance to make the system more efficient and to provide the player of the game insight into the next play in order to get the player to bet on the current play and/or the next play. For example, if there are two outs in a baseball game, and the count no balls and two strikes, the next pitch could lead to only several conclusions, e.g., another strike, or out ends the inning, or the inning may continue because there is a ball called, or there is a hit or a foul. The odds of each next possibility can be calculated based on averages of all games ever played between these two teams playing as well as the odds from the history of the given pitcher and the given batter which in the past as well as adding a further filter, such as geolocation, weather, etc. which are in a database. This is useful as a baseline odds calculations, as they are likely to be more accurate than calculated odds from generic history data, likely more accurate than calculated odds from team history data, and likely be more accurate than calculated odds from teams and the particular players on the teams' historical data. It should be noted that calculated odds could be based upon correlation calculations, such as but not limited to regression analysis, that is, if one of the possibilities of the next play is a walk, from 2 outs and two strikes, the frequency of a “walk” says 20% for all games, 25% for a score of 2 to 1, 30% for a score 3 to 1, 28% for a no players on base, 32% for three players on base, etc., so by evaluating each of these percentages for many cases, a best fit regression is 28.5% with a correlation coefficient of 95% which is enough confidence to suggest odds based upon 28.5% probability. This is just one example of how odds may be calculated.

Further, embodiments may include the hybrid odds module 134, which may be executed by receiving odds from the other odds calculation module 122 and then determining the next play and the odds of the next play in advance to make the system more efficient and to provide the player of the game insight into the next play in order to get the player to bet on the current play and/or the next play. For example, if there are two outs in a baseball game, and the count no balls and two strikes, the next pitch could lead to only several conclusions, e.g., another strike, or out ends the inning, or the inning may continue because there is a ball called, or there is a hit or a foul. The odds of each next possibility can be calculated based upon running the analysis of the generic odds module 126, the team odds module 128, the player odds module 130, and the filtered odds module 132, then determining if they are within a certain range to offer the least risky odds. It should be noted that calculated odds could be based upon correlation calculations, such as but not limited to regression analysis, that is, if one of the possible outcomes of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

Further, embodiments may include the bettor odds module 136, which may be executed by receiving odds from the other odds calculation modules 122 and then determining the next play and the odds of the next play in advance to make the system more efficient and to provide the player of the game insight into the next play in order to get the player to bet on the current play and/or the next play. For example, if there are two outs in a baseball game, and the count is no balls and two strikes, the next pitch could lead to only several conclusions, e.g., another strike, or out ends the inning, or the inning may continue because there is a ball called, or a hit, or a foul. The odds of each next possibility can be calculated based upon running the analysis of the generic odds module 126, the team odds module 128, the player odds module 130, and the filtered odds module 132, then determining if they are within a certain range to offer the least risky odds as well as including the performance of the bettor. So, a bettor that is winning a larger percentage of the time might be given lower odds than one who is losing more frequently. This allows for expertise currently vs. past data expertise. It should be noted that calculated odds could be based upon correlation calculations, such as but not limited to regression analysis, that is, if one of the possibilities of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

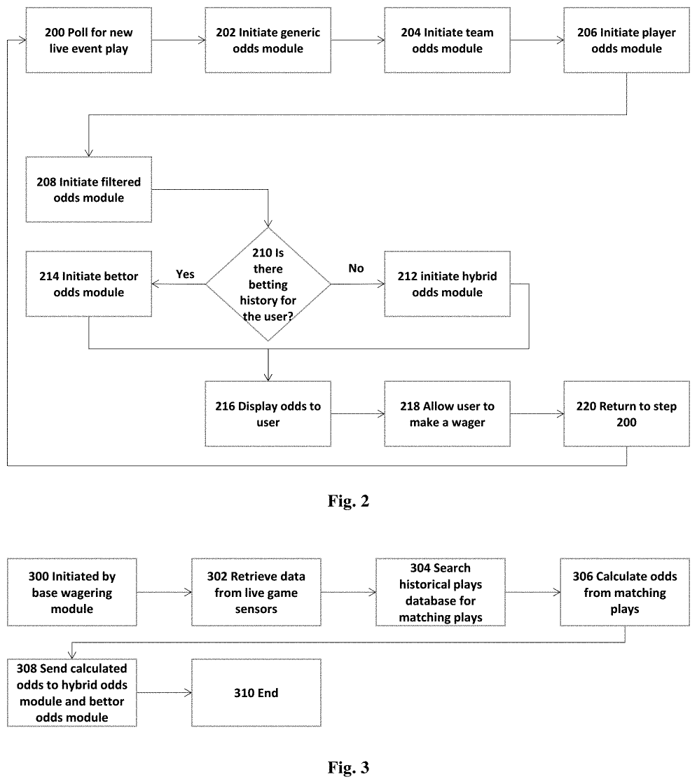

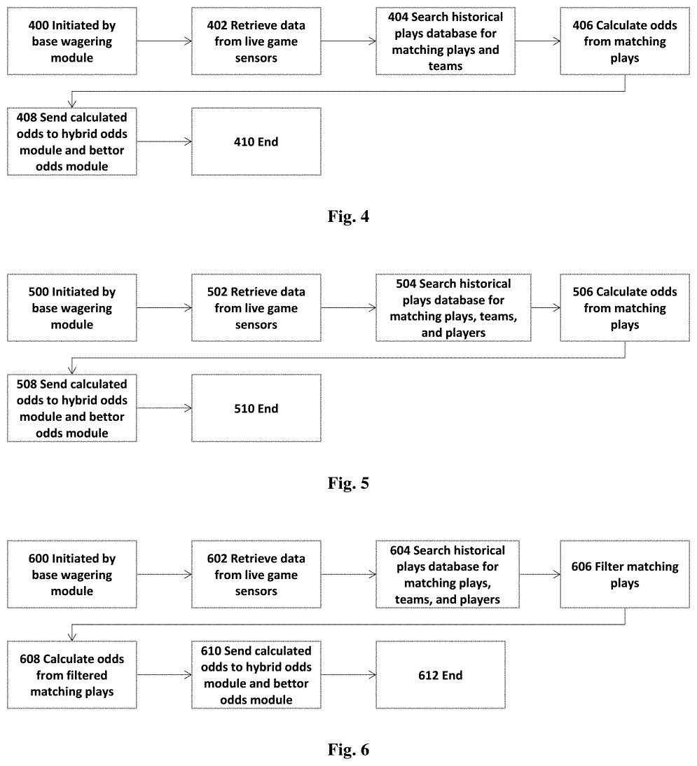

FIG. 2 illustrates the base wagering module 124. The process begins with the base wagering module 124 polling, at step 200, for a new play of the live event 102. The base wagering module 124 initiates, at step 202, the generic odds module 126. The base wagering module 124 initiates, at step 204, the team odds module 128. The base wagering module 124 initiates, at step 206, the player odds module 130. The base wagering module 124 initiates, at step 208, the filtered odds module 132. The base wagering module 124 determines, at step 210, if there is betting history data for the user in the user database 116. If there is no historical betting data on the user, the base wagering module 124 initiates, at step 212, the hybrid odds module 134. If there is historical betting data on the user, the base wagering module 124 initiates, at step 214, the bettor odds module 136. The base wagering module 124 displays, at step 216, the odds to the user via the wagering app 110. The odds may be obtained by the base wagering module 124 from the hybrid odds module 134 or the bettor odds module 136. The base wagering module 124 allows, at step 218, the user to place a wager. The wager may be placed via the wagering app 110 and stored in a database, for example, the user database 116. The base wagering module 124 returns, at step 220, to step 200.

FIG. 3 illustrates the generic odds module 126. The process begins with the generic odds module 126 being initiated at step 300 by the base wagering module 124. The generic odds module 126 retrieves, at step 302, data from the live event 102 via the sensors 104. The generic odds module 126 searches, at step 304, the historical plays database 118 for plays that match the data retrieved from the live event 102. For example, there are two outs in a baseball game, and the count is no balls and two strikes; the generic odds module 126 may search for plays with the same or similar conditions. The generic odds module 126 calculates, at step 306, the odds for the potential outcomes of the current play of the live event 102. The odds for each potential outcome may be calculated by determining the outcome's frequency for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The generic odds module 126 sends, at step 308, the calculated odds to the hybrid odds module 134 or the bettor odds module 136. The generic odds module 126 may determine which module is active and send the odds to that module, or may just send the odds to both. The generic odds module 126 ends at step 310.

The process begins with the team odds module 128 being, at step 400, initiated by the base wagering module 124. The team odds module 128 retrieves, at step 402, data from the live event 102 via the sensors 104. The team odds module 128 searches, at step 404, the historical plays database 118 for plays and teams that match the data retrieved from the live event 102. For example, there are two outs in a baseball game, and the count is no balls and two strikes in a game between the Angels and the Dodgers. The team odds module 128 will search for plays with the same or similar conditions. The team odds module 128 calculates, at step 406, odds for the outcome of the current play of the live event 102. Each outcome's odds may be calculated by determining the frequency of that outcome for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The team odds module 128 sends, at step 408, the calculated odds to the hybrid odds module 134 or the bettor odds module 136. The team odds module 128 may determine which module is active and send the odds to that module, or may just send the odds to both. The team odds module 128 ends at step 410.

FIG. 5 illustrates the player odds module 130. The process begins with the player odds module 130 being initiated at step 500 by the base wagering module 124. The player odds module 130 retrieves, at step 502, data from the live event 102 via the sensors 104. The player odds module 130 searches, at step 504, the historical plays database 118 for plays, teams, and players that match the data retrieved from the live event 102. For example, there are two outs in a baseball game, and the count is no balls and two strikes in a game between the Angels and the Dodgers. David Fletcher is at-bat, and Dustin May is pitching. The player odds module 130 will search for plays with the same or similar conditions. The player odds module 130 calculates, at step 506, odds for the outcome of the current play of the live event 102. Each outcome's odds may be calculated by determining the frequency of that outcome for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The player odds module 130 sends, at step 508, the calculated odds to the hybrid odds module 134 or the bettor odds module 136. The player odds module 130 may determine which module is active and send the odds to that module, or may just send the odds to both. The player odds module 130 ends at step 510.

FIG. 6 illustrates the filtered odds module 132. The process begins with the filtered odds module 132 being initiated at step 600 by the base wagering module 124. The filtered odds module 132 retrieves, at step 602, data from the live event 102 via the sensors 104. The filtered odds module 132 searches, at step 604, the historical plays database 118 for plays, teams, and players that match the data retrieved from the live event 102. For example, there are two outs in a baseball game, and the count is no balls and two strikes in a game between the Angels and the Dodgers. David Fletcher is at-bat, and Dustin May is pitching. The filtered odds module 132 will search for plays with similar conditions in the historical plays database 118. The filtered odds module 132 filters, at step 606, the matching plays based on filtering criteria such as geolocation, weather, time, etc. For example, if the filter is geolocation within 100 miles, all plays from outside 100 miles of the live event 102 may be excluded from the odds calculation. The filter may be set manually or automatically. Appropriate filters may be determined using an AI-based module. Multiple instances of the filtered odds module 132 may run simultaneously with different filtering criteria. The filtered odds module 132 calculates, at step 608, odds for the outcome of the current play of the live event 102. Each outcome's odds may be calculated by determining the frequency of that outcome for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The filtered odds module 132 sends, at step 610, the calculated odds to the hybrid odds module 134 or the bettor odds module 136. The filtered odds module may determine which module is active and send the odds to that module, or may just send the odds to both. The filtered odds module 132 ends at step 620.

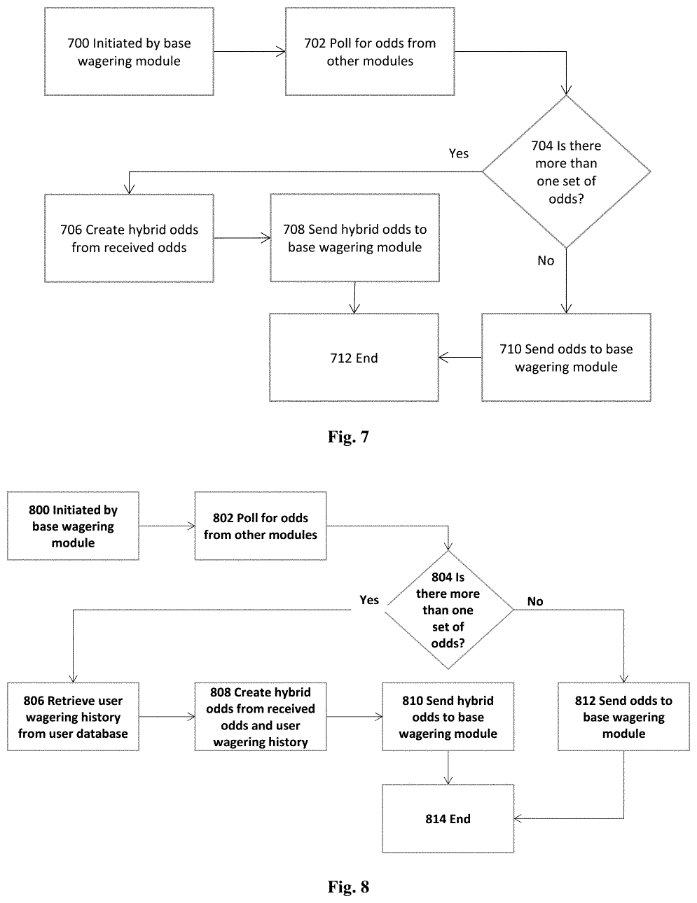

FIG. 7 illustrates the hybrid odds module 134. The process begins with the hybrid odds module 134 being, at step 700, initiated by the base wagering module 124. The hybrid odds module 134 polls, at step 702, for odds from the generic odds module 126, team odds module 128, player odds module 130, and filtered odds module 132. The hybrid odds module 134 may wait a set amount of time after the first set of odds has been received before moving on to step 704. Sets of odds that take too long to generate may not be included in the hybrid odds calculation for the current play of the live event 102. The hybrid odds module 134 determines, at step 704, if more than one set of odds was received. If more than one set of odds was received, the hybrid odds module 134 creates, at step 706, hybrid odds based on the received odds. Hybrid odds may be generated by averaging all of the received sets of odds, selecting the lowest risk set of odds, selecting the most accurate set of odds, averaging a subset of the received odds, etc. For example, if the hybrid odds generation method is the average of all received odds, and the received odd for the outcome to be an “out” are 1:3 odds and 1:4 odds, then the hybrid odds for the outcome to be an “out” would be 1:3.5 or 2:7. The hybrid odds module 134 sends, at step 708, the created hybrid odds to the base wagering module 124. If only one set of odds was received, the hybrid odds module 134 sends, at step 710, the received odds to the base wagering module 124. The hybrid odds module ends at step 712.

FIG. 8 illustrates the bettor odds module 136. The process begins with the bettor odds module 136 being, at step 800, initiated by the base wagering module 124. The bettor odds module 136 polls, at step 802, for odds from the generic odds module 126, the team odds module 128, the player odds module 130, and the filtered odds module 132. The bettor odds module 136 may wait a set amount of time after the first set of odds has been received before moving on to step 804. Sets of odds that take too long to generate may not be included in the hybrid odds calculation for the current play of the live event 102. The bettor odds module 136 determines, at step 804, if more than one set of odds was received. If more than one set of odds was received, the bettor odds module 136 retrieves, at step 806, the user's wagering history from the user database 116. The bettor odds module 136 creates, at step 808, user-specific hybrid odds based on the received odds. User-specific hybrid odds may be generated by averaging all of the received sets of odds, selecting the lowest risk set of odds, selecting the most accurate set of odds, averaging a subset of the received odds, etc. There may be other ways to determine final odds, such as taking the median of the received odds. For example, if the user-specific hybrid odds generation method is the average of all received odds, and the received odd for the outcome to be an “out” are 1:3 odds and 1:4 odds, then the hybrid odds for the outcome to be an “out” would be 1:3.5 or 2:7. The method of creating user-specific hybrid odds may be adjusting the user-specific hybrid odds, or both may be based on the user's wagering history. For example, a user who rarely places wagers on low odds may cause the bettor odds module to select the highest of the received odds to be the user-specific hybrid odds or may give the highest odds more weight when taking an average of the received odds. The received odds may be modified if the bet is otherwise unfavorable to the user. For example, if user Bob has a history of betting on the Dodgers, the odds of a bet for another team may be adjusted to be more favorable, while the odds of betting on the Dodgers may remain unchanged or even adjusted to be less favorable. In one embodiment, artificial intelligence may also be used to compare the range of odds received to the range of odds generated for similar plays in the past. For example, the gap between the highest and lowest odds returned on a given outcome may be compared to the amount of action wagered on that play or the profit to the house. That comparison may be made through linear regression, cross-correlation, or another mathematical model to identify the most profitable odds or the odds that generated the most action. The bettor odds module 136 sends, at step 810, the created user-specific hybrid odds to the base wagering module 124. If only one set of odds was received, the bettor odds module 136 sends, at step 812, the received odds to the base wagering module 124. The bettor odds module ends at step 814.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for generating odds in a play-by-play sports betting network comprising:
a database storing wagers of a play-by-play wagering game during a live sporting event, and
an odds calculation module that performs at least four different calculations for odds on a play of the live sporting event, and
a hybrid odds module that receives odds from the odds calculation module and determines hybrid odds using at least two of the four different calculated odds, wherein the hybrid odds are for a play immediately following a next play and the odds are modified based on historical data.

2. The system for generating odds in a play-by-play sports betting network of claim 1, wherein the historical data comprises historical user bettering behavior.

3. The system for generating odds in a play-by-play sports betting network of claim 1, further comprising a filtered odds module that determines if the next play matches one or more criteria associated with one or more plays in a historical plays database.

4. The system for generating odds in a play-by-play sports betting network of claim 3, wherein the one or more matching plays determined by the filtered odds module are interpreted by the hybrid odds module to determine the hybrid odds.

5. The system for generating odds in a play-by-play sports betting network of claim 1, wherein the hybrid odds module uses the at least two of the four different calculated odds which have the lowest risk.

6. The system for generating odds in a play-by-play sports betting network of claim 1, wherein the hybrid odds module uses the at least two of the four different calculated odds which are the fastest to calculate.
